(19) United States
(12) Patent Application Publication
(10) Pub. No.: US 2022/0152814 A1
(43) Pub. Date: May 19, 2022

(54) DRIVE SYSTEM

(71) Applicant: Festo SE & Co. KG, Esslingen (DE)

(72) Inventors: Simon Markowski, Esslingen (DE); Marc Hauck, Poing (DE)

(21) Appl. No.: 17/434,627

(22) PCT Filed: Feb. 27, 2020
(86) PCT No.: PCT/EP2020/055129

§ 371 Date: Aug. 27, 2021

(30) Foreign Application Priority Data
Mar. 4, 2019 (DE) 10 2019 202 897.7

(51) Int. Cl. B25J 9/12

(52) U.S. Cl. CPC B25J 9/123

(57) ABSTRACT

A drive system (1) which is designed in particular as a robot (1a) and has a linear drive (2), on the drive unit (7) of which, which can be driven to perform a drive movement (8), a working unit (3) is mounted with an interface module (4) being connected therebetween. The working unit (3) has at least one fluidic actuator (54) and at least one electrical actuator (63). The linear drive (2) is accommodated in a casing body (67) which has a longitudinal slot (74) through which the interface module (4) passes. A flexurally resilient fluid tube arrangement (95) and a likewise flexurally resilient power cable arrangement (97), both of which lead to the interface module (4), extend in a casing-body interior (68) which is enclosed by the casing body (67), wherein a fluidic connection and an electrical connection to the working unit (3) are produced through the interface module (4).

The invention relates to a drive system, with a linear drive which comprises a drive housing and a drive unit which is displaceable with respect to this in the axis direction of a longitudinal axis of the linear drive whilst carrying out a linear drive movement, wherein the drive unit comprises a driven section which is accessible outside the drive housing and which moves along a linear stroke path given the drive movement, and with a working unit which is linearly displaceable and positionable by the drive movement of the drive unit, is fastened to the driven section of the drive unit and comprises at least one electrically actuatable electrical actuator device.

Such a drive system in GB 2481249 A is designed as a robot and comprises an electrically actuatable linear drive which is installed with a vertical axis, so that the drive unit can be driven into a vertical linear drive movement. A robot arm which comprises several joints which are each formed by an electrical actuator device in the form of an electrically actuatable rotary drive, as a working unit is fastened to the drive unit.

A robot which is provided with an interface for the connection of supply leads to a robot hand, wherein the robot is fastened to a robot arm, is known from DE 10 2016 009 546 A1.

DE 20 2011 002 899 U1 describes a robot arm which is provided with a tool changer which is provided with a rotary feed-through for media, in order for example to be able to lead through hydraulic or pneumatic media. The rotary feed-through comprises a fixed part and a rotary part which is rotatable with respect to this, and is further provided with annular channels which run concentrically to a drive axis of the robot arm.

An adapter for industrial robots is described in DE 20 2006 004 772 U1, said adapter permitting the mechanical attachment of end effectors such as tools or grippers onto industrial robots. The adapter is provided with several different bore patterns which permit the attachment of different robot connecting flanges.

DE 10 2017 215 942 A1 describes a robot of the SCARA type which comprises a base and a joint arm which is pivotable with respect to the base and which is subdivided by way of at least one arm link into several arm links which are pivotable relative to one another.

DE 199 34 965 A1 describes a robot with a multi-joint arms which are movable in a horizontal plane. A robot body has a cylindrical holder which is movable in the vertical direction and on which a first arm is attached, to which first arm in turn a movable second arm is connected.

A handing apparatus unit which comprises a movable holding device which holds a main cylinder which is designed as a piston rod-less cylinder which comprises a force output member which is connected to the holding device is described in DE 33 39 227 A1.

US 2017/0 217 013 A1 describes a device with a tower which is covered by a shell, wherein the tower comprises a base with a first movement axis for a movement about a first joint, a first arm which is connected to the tower along a second movement axis via a second joint, and a second arm which is connected to the first arm at the proximal end of the second arm via a third joint. The second arm has an end effector interface which is configured such that it can hold a multitude of end effectors which are suitable for different applications.

US 2010/0 163 694 A1 describes a stand with an arm which is vertically movably mounted on a vertical column via vertical guide, for holding an object, wherein a counter-weight which compensates the weight of the arm is provided on or in the vertical column Furthermore, a device for moving the counter-weight counter to the weight force for an at least partial lifting of the weight compensation is present.

U.S. Pat. No. 4,566,847 A describes a positioning device for the positioning of a robot arm of an industrial robot which comprises a frame element which is connected to the robot arm and is movably carried by a frame carrier element.

It is the object of the invention to provide a drive system which can be used for example in robot technology and which with a lower danger of damage permits a reliable supply of media to a working unit which is displaceable by a linear drive.

For achieving this object, with regard to a drive system which comprises the aforementioned features, according to the invention, one additionally envisages,
(a) that the working unit also comprises at least one fluidic actuator device which can be actuated by fluid force,
(b) that the working unit is fastened to the driven section of the linear drive amid the intermediate arrangement of an interface module which participates in the drive movement, wherein the interface module comprises an interface module body which has a first mechanical fastening interface and a second mechanical fastening interface and which is fastened to the driven section via the first mechanical fastening interface and to whose second mechanical fastening interface the working unit is fastened,
(c) that the drive system comprises an enveloping body which at least peripherally encompasses the linear drive and which comprises a longitudinal slot which extends along the linear stroke path of the driven section of the linear drive and through which the interface module projects, wherein an inner module body section of the interface module body which comprises the first fastening interface is arranged within an enveloping body interior which receives the linear drive, and an outer module body section of the interface module body which comprises the second fastening interface is arranged outside this enveloping body interior,
(d) that at least one fluid transmission channel passes through the interface module body and with an inner channel opening runs out at the inner module body section and with an outer channel opening runs out at the outer module body section, the at least one fluid transmission channel being designed for the fluid transmission of a fluidic pressure medium which is provided for the operation of the at least one fluidic actuator device,
(e) that at least one electricity transmission channel passes through the interface module body and with an inner channel opening runs out at the inner module body section and with an outer channel opening runs out at the outer module body section, at least one electricity transmission channel being designed for electricity transmission of an electrical current which is provided for the operation of the at least one electrical actuator device,
(f) that inside the enveloping body interior a bending-flexible fluid tube arrangement which is designed for the transmission of the fluidic pressure medium is fed onto the inner channel opening of the at least one fluid transmission channel, and
(g) that furthermore inside the enveloping body interior a bending-flexible electricity cable arrangement which is designed for the transmission of the electrical current is fed onto the inner channel opening of the at least one electricity transmission channel,
(h) wherein at least one fluid connection to the working unit is formed coming from the outer channel opening of the at least one fluid transmission channel and wherein at least one electrical connection to the working unit is formed coming from the outer channel opening of the at least one electricity transmission channel

The drive system according to the invention has a linear drive with a drive unit which can be driven into a linear drive movement with respect to a drive housing and onto which a working unit is built amid the intermediate arrangement of an interface module, said working unit comprising at least on electrical actuator device and at least one fluidic actuator device. Concerning the fluidic actuator device, this for example is a fluid-actuated rotary drive. Concerning the electrical actuator device, this for example is an electrically actuated valve or a valve drive of a control valve device. The linear drive is encompassed at least peripherally, thus in the region of its radial outer periphery, by a enveloping body which for example consists of a durable and weight-saving plastic material, for the shielding with regard to environmental influences. A longitudinal slot, through which the interface module passes and along which the interface module can move given a drive movement of the drive unit is formed in the enveloping body. The interface module has an interface module body with an inner module body section which is arranged within the enveloping body and with an outer module body section which is arranged outside the enveloping body. A mechanical fastening interface, via which the interface module is fastened on the one hand to a driven section of the drive unit of the linear drive and on the other hand to the working unit which is located outside the enveloping body, is located on each of these two module body sections. The interface module body can be designed in a very narrow manner in the region of the longitudinal slot, in order to permit a correspondingly narrow longitudinal slot which combats a penetration of contamination even if it has no flexible cover, which however can nonetheless also be present. The interface module is not only responsible for the mechanical connection between the drive unit of the linear drive and the working unit, but also yet assumes an energy feed-through function in regard to a fluidic pressure medium as well as an electrical current. At least one transmission channel passes through the interface module body for both energy types, which means at least one fluid transmission channel and at least one electricity transmission channel Preferably, the electrical current is led through by way of one or more electricity cables, whereas the fluidic pressure medium is led through in a direct manner, but in principle can also be led through by way of one more fluid tubes. The electrical current is transmitted for example as pure operating energy and/or in the form of electrical control signals. The enveloping body encompasses an enveloping body interior which receives the linear drive and in which for the fluid transmission a bending-flexible fluid tube arrangement and for the electric current transmission a bending-flexible electricity cable arrangement is led onto the inner module body section of the interface module body. The energy transmission to the working unit is effected outside the enveloping body by way of suitable fluid connections and electrical connections. These can be realised in an integrated manner or by way of fluid tubes and/or electricity cables.

Advantageous further developments of the invention are to be derived from the dependent claims

The linear drive is preferably an electric linear drive or a fluid-actuated linear drive, the latter preferably in the embodiment of as a pneumatic linear drive. A hybrid construction in a combined electrical and fluidic manner is also possible.

The linear drive is preferably of a rod-less type being without a piston rod, so that its longitudinal dimensions do not change during the designated operation. The drive unit has a drive section which is linearly movable in the drive housing and which can be impinged by a drive force creating the drive movement. With regard to the fluid-actuated linear drive, the drive section is a drive piston which can be impinged by a fluidic pressure medium. The drive section with regard to drive is coupled through a peripheral housing wall of the drive housing to the driven section which is arranged outside the drive housing, wherein it is advantageous if the driven section is guided in a linearly displaceable manner on the drive housing. The coupling, with regard to drive between the drive section and the driven section can be effected in a contact-free manner by way of a permanent-magnetic magnet arrangement, but is however expediently realised mechanically with the help of a driver section of the drive unit which passes through a longitudinal slot of the peripheral housing wall of the drive housing.

Concerning an alternative possible electrical piston-rod-free linear drive, the drive section in the manner of a nut can comprise an inner thread, said inner thread being seated on a drive spindle which extends linearly in the inside of the drive housing and which is rotatably driveable by way of an electric motor, so that a linear movement of the drive section which is in threaded engagement therewith results from the rotation movement of the drive spindle.

The electricity cable arrangement and the fluid tube arrangement are expediently led within the enveloping body interior by a so-called drag chain which is located there. The drag chain at one end is fastened to the drive housing of the linear drive in a stationary manner and at the other end is fastened to the interface module body in a stationary manner, wherein on the part of the interface module body, the fastening is effected to the inner module body section and thus within the enveloping body interior. The inner module body section for this purpose has a third mechanical fastening interface which is present additionally to the two first and second fastening interfaces which are formed on the interface module body for the fixation of the drive section and the working unit. Instead of a drag chain, another support device which is flexible transversely to its longitudinal direction can also be provided, for example an elastic, helical spiral structure.

Each mechanical fastening interface is expediently designed for the screw-fastening of the components which are attached thereto. For this purpose, it comprises in particular a plurality of fastening holes for fastening screws. The fastening holes can be provided as through-holes or as threaded holes with an inner thread, depending on the type of screw fastening. The respective hole pattern can be matched very simply to the circumstances of the drive unit and of the working unit.

The first mechanical fastening interface which is designed for the attachment to the drive unit of the linear drive is expediently located on an inner fastening base of the inner module body section of the interface module body. In a comparable manner, the second mechanical fastening interface which serves for the fixation of the working unit is preferably formed on an outer fastening base of the outer module body section of the interface module body. Both fastening bases with regard to the design can be individually adapted to the fastening task to be fulfilled and in particular are wider than the longitudinal slot of the enveloping body, through which slot the interface module engages. A connection web which is narrower than the two fastening bases and which connects the fastenings bases to one another extends through the longitudinal slot, so that the longitudinal slot of the enveloping body can be designed in a very narrow manner

The interface module body is expediently designed as one piece. Preferably, it consists of steel or an aluminium material.

The two fastening bases with regard to their width and length can be designed equally or differently. They preferably have an equal maximal width, whereas the outer fastening base in a longitudinal direction which coincides with the axis direction of the longitudinal axis of the linear drive is expediently shorter than the first fastening base.

It is seen as being advantageous if the outer fastening base comprises at least two centring deepenings which are distanced to one another and into which a centring projection of the working unit positively engages, said working unit being attached to the outer fastening base. By way of this, the working unit is reliably held on the interface module in a positionally correct manner even with shakings. Preferably, two centring deepenings are present and these are arranged distanced to one another in the longitudinal direction of the outer fastening base. These are designed for example in a groove-like manner

The electricity cable arrangement which is used for the electricity supply of the working unit expediently does not end at the interface module but is laid through the at least one electricity transmission channel It enters into the electricity transmission channel at the inner channel opening which lies within the enveloping body, and leaves this electricity transmission channel outside the enveloping body in the region of the outer channel opening of the electricity transmission channel. At least one outer electricity cable section which projects out of the electricity transmission channel is expediently laid outside the interface unit towards the working unit.

The electricity transmission channel, through which the electricity cable arrangement passes can be a peripherally closed channel and be designed for example in the manner of a bore. The cable laying work however becomes simpler if the electricity transmission channel is designed in a groove-like manner, so that it comprises a slot-like longitudinal-side channel opening which extends transversely through the longitudinal slot of the enveloping body and between two face-side channel openings of the electricity transmission channel, of which the one is arranged within and the other outside of the enveloping body interior. The electricity cable arrangement can be laid very simply from the side through the slot-like, longitudinal-side channel opening into the current transmission cable.

Preferably, the groove-like electricity transmission channel is formed on one of the two end-faces of the interface module body which are orientated in the longitudinal direction of the interface module.

It has been found to be expedient if one or more binder holes which in the region of the groove flanks run out into the groove-like electricity transmission channel pass through the interface module body. These binder holes permit the leading-through of a binding element which is designed for example as a cable binder and by way of which the electricity cable arrangement can be fixedly held in the electricity transmission channel

The interface module expediently has an individual imaginary longitudinal axis which is aligned parallel to the longitudinal axis of the linear drive, a height axis which is orientated radially with respect to the longitudinal axis of the linear drive and a transverse axis which is at right angles to the longitudinal axis and to the height axis and extends in the width direction of the longitudinal slot of the enveloping body.

The inner channel opening of the at least one fluid transmission channel is preferably arranged on a longitudinal side of the interface module body which is orientated in the transverse direction of the interface module, so that it is easily accessible for the connection of the fluid tube arrangement. The outer channel opening of the at least one fluid transmission channel is preferably located on an upper side of the interface module body which faces away from the linear drive and is orientated in the axis direction of the height axis.

In the context of an outer fastening base, it is advantageous if the outer channel opening of the at least one fluid transmission channel is arranged next to this external fastening base. It is seen as being particularly advantageous if the outer channel opening of the at least one fluid transmission channel is located on the connection web next to the outer fastening base.

Expediently, the at least one fluid transmission channel is designed for the direct leading of fluid of the fluidic pressure medium which is to be transmitted. Herein, the fluid tube arrangement does not extend through the fluid transmission channel A tube connection unit, onto which the fluid tube arrangement is connected in a preferably releasable manner with an inner fluid tube section which extends within the enveloping body and with at least one outer fluid tube section which extends outside the enveloping body, is arranged on the inner and outer channel opening of each fluid transmission channel. The tube connection units in particular are designed as plug connection units, but can also be designed as a simple screw-in thread.

The drive system is preferably provided with an internal electronic control unit which controls the operation of the individual system components. This internal electronic control unit is preferably located in the enveloping body interior, wherein it is preferably built directly or indirectly onto the drive housing of the linear drive. It can be composed of several electronic control modules which are electrically connected to one another and which are placed in a distributed manner.

The electricity cable arrangement which leads to the working unit is expediently connected onto the internal electronic control unit within the enveloping body interior. The fluid tube arrangement which is responsible for the fluid supply of the working unit is expediently connected in the enveloping body interior onto a fluidic interface module which is designed for feeding and discharging a fluidic pressure medium. The electricity cable arrangement expediently consists of only a single bus cable with whose help a series bus system is realised, in particular a so-called CAN bus system.

The fluid tube arrangement which leads to the working unit expediently comprises two fluid tubes, of which the one is responsible for the fluid feed and the other for the fluid discharge.

The enveloping body is expediently fastened to the drive housing of the linear drive in a direct or indirect manner Suitable fastening elements can be present for this. For example, the drive housing is fastened to a base structure via fastening struts, wherein the enveloping body is fixed on the fastening struts.

The enveloping body expediently comprises a tube-shaped wall section which peripherally encompasses the linear drive all around and in which the longitudinal slot through which the interface module passes is formed. At the face side, the enveloping body interior can likewise be closed by the enveloping body, but it can also remain open. Concerning an installation with a vertical alignment of the longitudinal axis of the linear drive, it is expedient if the enveloping body at its upper side has a terminating cover which closes the enveloping body interior and which is fixed on the tubular wall section.

Preferably, at least one fluidic actuator device of the working unit is designed as a fluid-actuated rotary drive. Such a fluid-actuated rotary drive can form an active joint which is integrated into the working unit. The working unit can comprise only a single fluidic actuator device or several such fluidic actuator devices. Preferably, each fluidic actuator device is designed as a pneumatic actuator device which can be operated with pressurised air as a fluidic pressure medium.

At least one electric actuator device of the working unit is expediently formed by a valve which belongs to a control valve device of the working unit and which is electrically actuated. With regard to the valve, it is for example a magnet valve or preferably a piezo-valve. The piezo-valve as an actuator element in particular comprises a piezoelectric bending actuator. Concerning an electro-fluidically piloted control valve device, an electrical actuator device can consist of a valve drive which functions as a pilot valve.

Preferably, the fluidic actuator devices of the working unit with regard to operation are controlled by at least one control valve device of the working unit. The electrical control commands which are necessary for this can be provided by the internal electronic control unit which is mentioned further above. Additionally, the working unit can be decentrally provided with at least one electronic supplementary control unit. For example, each of the fluidic actuator devices is provided with such an electronic supplementary control unit.

The drive system can be applied for arbitrary purposes. Its design as a robot is seen as being particularly advantageous, wherein the working unit represents a robot arm. The robot is preferably a so-called SCARA robot.

The invention is hereinafter explained in more detail by way of the accompanying drawings. In these are shown in:

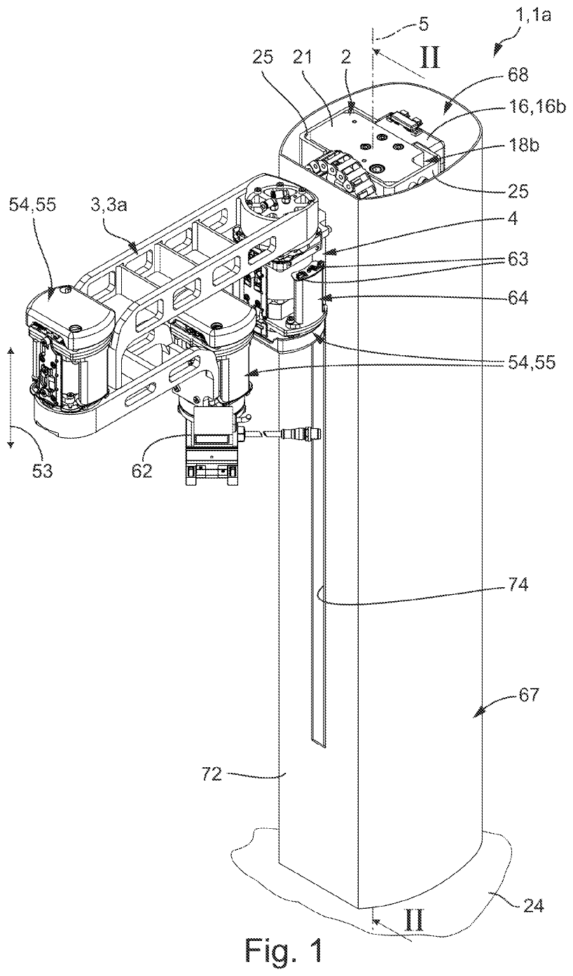

FIG. 1 an isometric representation of a preferred embodiment of the drive system according to the invention,

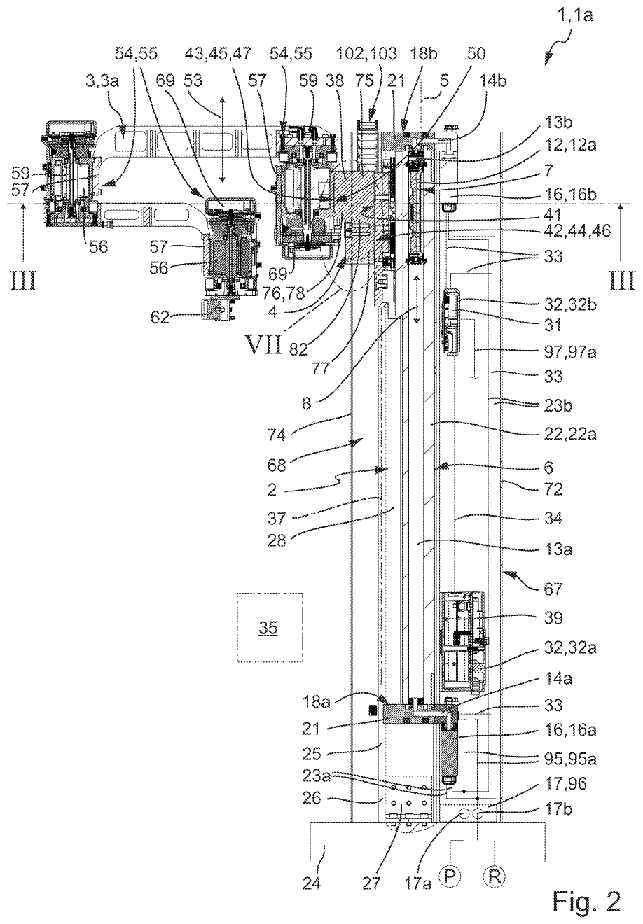

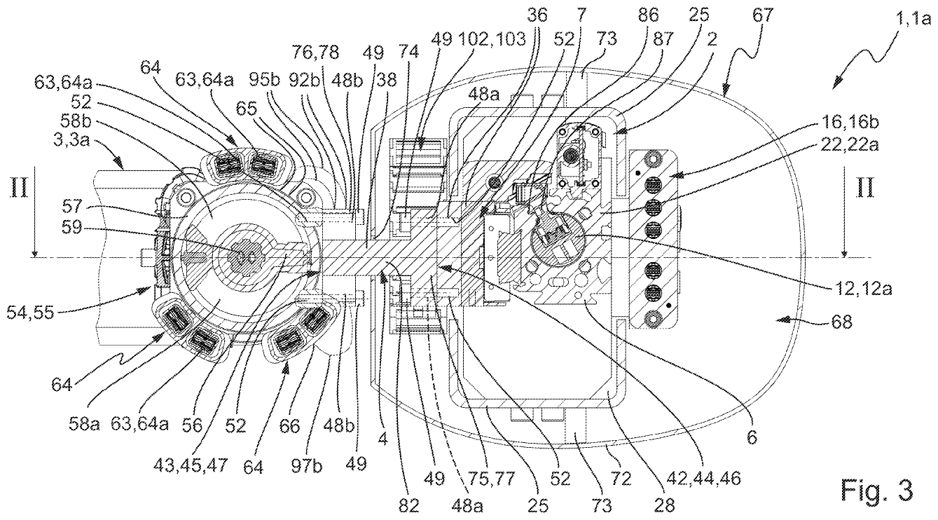

FIG. 2 a longitudinal section of the drive system according to section line II-II of FIGS. 1 and 3,

FIG. 3 a cross section of the drive system according to section line of FIG. 2,

FIG. 4 an isometric representation of the drive system according to FIG. 1, but without an enveloping body,

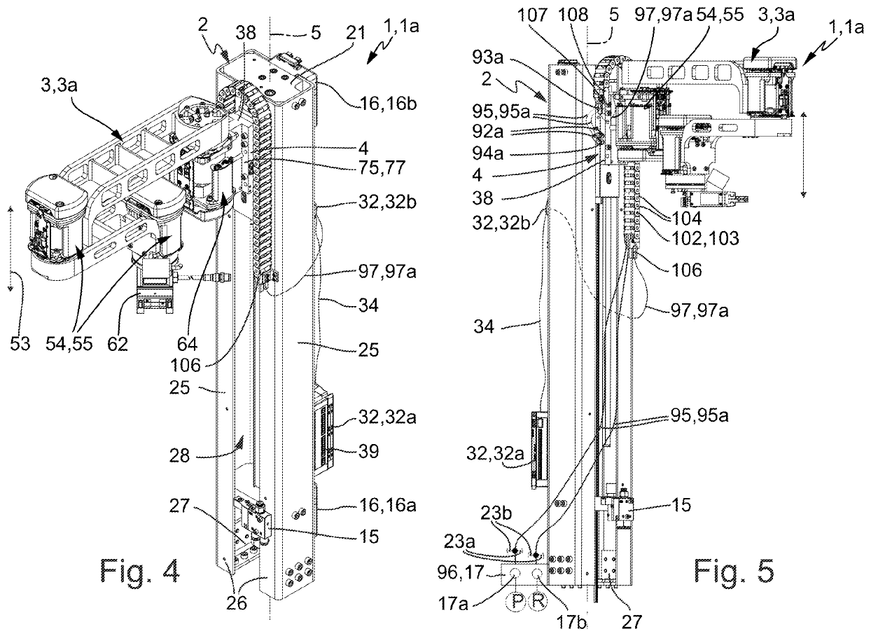

FIG. 5 the drive system of FIG. 4 from another viewing direction and again without the enveloping body,

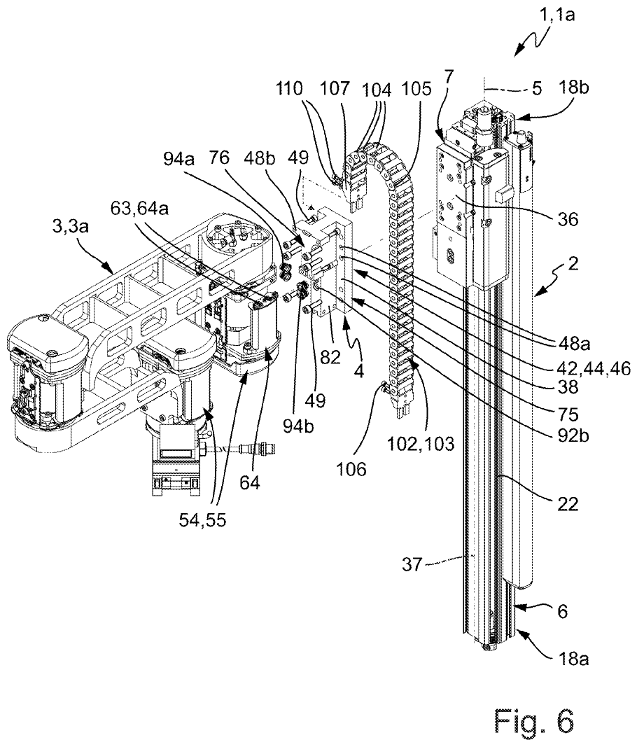

FIG. 6 an isometric exploded representation of the arrangement according to FIG. 4 whilst omitting a few components,

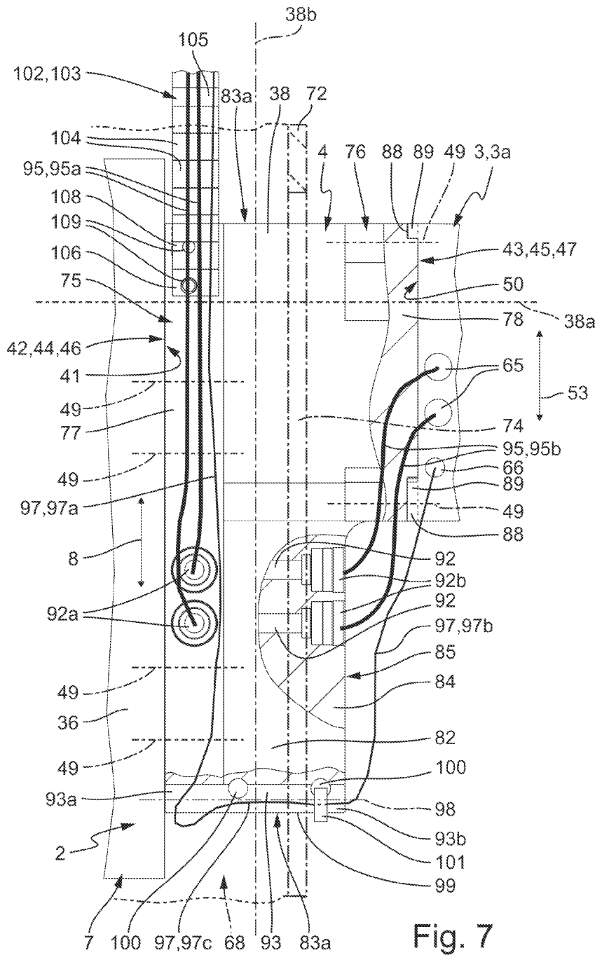

FIG. 7 an enlarged schematic representation of the detail VII which in FIG. 2 is framed in a dot-dashed manner, wherein in particular the interface module which passes through the longitudinal slot of the enveloping body is shown, said enveloping body only being indicated in a dot-dashed manner,

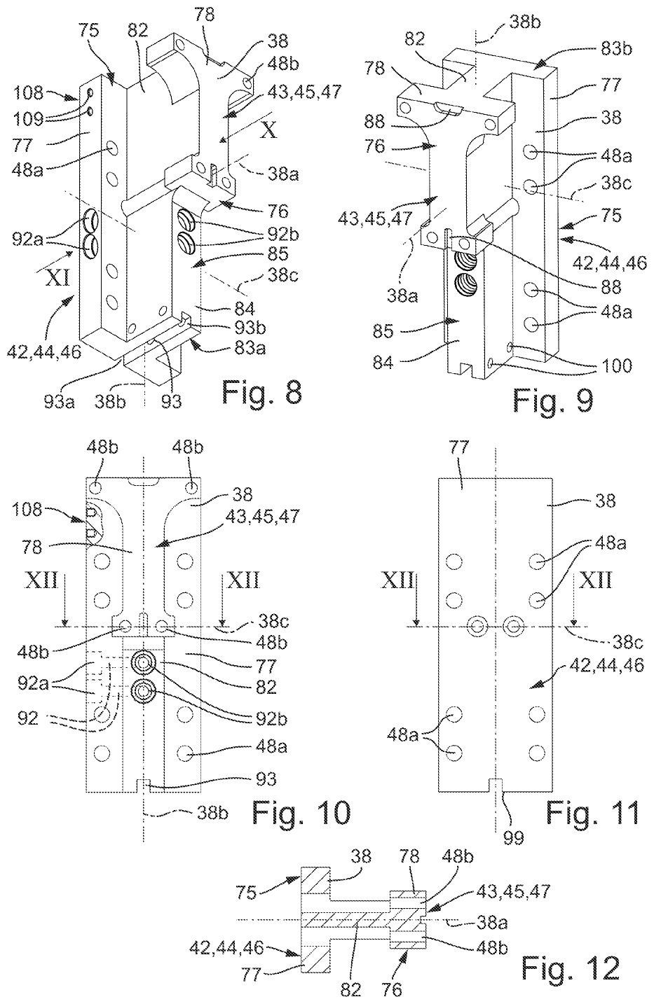

FIG. 8 an isometric individual representation of the interface module body which is contained in the drive system of FIGS. 1 to 7,

FIG. 9 the interface module body of FIG. 8 from a different viewing direction,

FIG. 10 the interface module body of FIGS. 8 and 9 in a plan view upon the upper side with a viewing direction according to arrow X from FIG. 8,

FIG. 11 a lower view of the interface module of the FIGS. 8 to 10 with a viewing direction according to arrow XI and

FIG. 12 a cross section of the interface module of FIGS. 8 to 11 according to the section line XII-XII of FIGS. 10 and 11.

The drive system which is denoted in its entirety with the reference numeral 1 comprises a linear drive 2, an electro-fluidic working unit 3 and an interface module 4, wherein the working unit 3 is fastened to the linear drive 2 by the interface module 4.

The linear drive 2 has a longitudinal axis 5 and in the preferred application case which is illustrated in the drawing is arranged such that the longitudinal axis 5 is aligned vertically. The further explanation relates to this preferred application case, wherein it should be mentioned that the linear drive 2 in principle can also be integrated into the drive system 1 at any other spatial alignment.

The axis direction of the longitudinal axis 5 is hereinafter also denoted as the longitudinal direction 5 of the linear drive whilst using the same reference numeral.

The linear drive 2 has a drive housing 6 which extends in the longitudinal direction 5 and a drive unit 7 which is movable relative to the drive housing 6 in the longitudinal direction 5. The linear movement which can be orientated in both axis directions of the longitudinal axis 5 and which can herein be carried out by the drive unit 7 is hereinafter denoted as the drive movement 8.

The drive unit 7 has a drive section 12 which is linearly movably arranged in the inside of the drive housing 6 and upon which a drive force can be exerted, in order to generate the drive movement 8. By way of example, the drive section 12 is formed by a drive piston 12a which axially subdivides the interior of the drive housing 6 into two drive chambers 13a, 13b which are hereinafter also denoted as the first and second drive chambers 13a, 13b. Given the exemplary alignment of the linear drive 2, the second drive chamber 13b lies above the first drive chamber 13a.

An individual drive channel 14a, 14b runs out into each drive chamber 13a, 13b, through which drive channel the assigned drive chamber 13a, 13b can be subjected to a fluidic pressure medium in a controlled manner, in order to generate a drive force which acts upon the drive section 12 and from which the drive movement 8 results. The relative positions with respect to the drive housing 6 which are passed by the drive unit 3 in the course of the drive movement 8 are denoted as stroke positions. On account of the pressure subjection of the two drive chambers 13a, 13b which is matched to one another, the drive unit 7 can be fixedly held which is to say positioned in any arbitrary stroke position. The drive channels 14a, 14b are expediently integrated into the drive housing 6 of the linear drive 2.

Optionally, the linear drive 2 can be provided with a locking brake, by way of which the drive unit 7 can be releasably fixed, which means blocked, in every arbitrary operating position by way of mechanical engagement. The braking function is expediently controlled by fluid pressure, wherein a brake control valve which is suitable for this is represented at 15.

The drive system 1 comprises an electrically actuatable control valve device 16 which is connected onto a fluidic connection device 17 which for the improved differentiation is denoted as a drive connection device 17 and which for its part is connected to a pressure source P and to a pressure sink R on operation of the drive system 1.

The pressure source P provides a fluidic pressure medium which is suitable for actuating the linear drive 2, said pressure medium preferably being pressurised air. Its connection to the drive connection device 17 in particular is realised by a tube connection.

The pressure sink R is preferably formed by the atmosphere. The connection of the drive connection device 17 to the atmosphere is realised for example by a tube connection or by a sound absorber. Given a likewise possible operation by way of a pressurised liquid as a fluidic pressure medium, the pressure sink R is formed for example by a pressurised liquid reservoir which is under atmospheric pressure.

The drive connection device 17 has a drive fluid feed connection 17a which can be used for connection to the pressure source P and a drive fluid delivery connection 17b which can be used for connection to the pressure sink. The control valve device 16 is connected to the drive connection device 17 via connection units which are not illustrated further, and are connected through the drive connection device 17 to the drive fluid feed connection 17a and to the drive fluid delivery connection 17.

The control valve device 16 is designed such that each drive channel 14a, 14b can be selectively connected to the drive fluid feed connection 17a or to the drive fluid delivery connection 17b. The control valve device 16 is preferably also in the position of simultaneously separating the drive channel 14a, 14b which is assigned to it, from both connections 17a, 17b, in order to block the pressure medium which is contained in the assigned drive chamber 13a, 13b.

Preferably and corresponding to the illustrated embodiment example, the control valve device 16 comprises two separate control valve units 16a, 16b, wherein a first control valve unit 16a controls the first drive channel 14a which is connected to the first drive chamber 13a, whereas the second control valve unit 16b is capable of controlling the second drive channel 14b which is connected to the second drive chamber 13b. Both control valve units 16a, 16b are designed in an electrically actuatable manner They are preferably actuated in a direct electrical manner, but they can also be of a pilot construction type.

The drive housing 6 has two end sections 18a, 18b which are opposite to one another. A first housing end section 18a by way of example faces downwards, whereas a second housing end section 18b faces upwards. Expediently, a housing cover 21 of the drive housing 6 is located on each of the two housing end sections 18a, 18b, wherein a housing tube 22 of the drive housing 6 extends between the two housing covers 21, said housing tube forming a peripheral housing wall 22a of the drive housing 6 which encompasses the two drive chambers 13a, 13b.

Expediently, the first control valve unit 16a is fastened to the first housing end section 18a whilst the second control valve device 16b is fastened to the second housing end section 18b. The control valve units 16a, 16b are preferably constructed on the drive housing 6 laterally at the outside, wherein they are fastened in particular to the respectively assigned housing cover 21.

The first control valve unit 16a is connected via first valve connection channels 23a onto the drive fluid feed connection 17a and onto the drive fluid delivery connection 17b. The same connections 17a, 17b are connected onto the second control valve unit 16b via two valve connection channels 23b. The valve connection channels 23a, 23b can each be designed as bore-like fluid channels and/or as channels in fluid conduits or fluid tubes.

The fluidic drive connection device 17 is placed by way of example in the region of the first housing end section 18a. In this case, the second valve connection channels 23b which with the embodiment example are formed by external fluid tubes can be designed completely or partially as fluid channels which extend in the wall of the drive housing 6.

The linear drive 2 is preferably fastened to a base structure 24 for setting an alignment in accordance with operation. The base structure 24 can for example be a base plate or a tabletop. Two fastening struts 25 which extend longitudinally next to the drive housing 6 and to which the drive housing 6 is fastened are arranged at the outside on the drive housing 6 of the linear drive 2, for the base-side fastening. The fastening is expediently effected to the two housing covers 21, onto which the fastening struts 25 are screwed by way of example with fastening screws 28.

The fastening struts 25 each with a fastening end section 26 project beyond the first housing end section 18a of the drive housing 6 and are releasably screwed to the base structure 24 via fastening brackets 27 or other fastening elements or are fixedly connected in another manner.

The two fastening struts 25 are preferably each formed by a U-profile element and are arranged such that the U-openings face the drive housing 6. Since the fastening struts 25 furthermore lie diametrically opposite with respect to the longitudinal axis 5, together they delimit a receiving space 28, in which the drive housing 6 of the linear drive 2 extends. Expediently, the two housing covers 21 project radially beyond the housing tube 22 of the drive housing 6, wherein sections of the housing covers 21 project into the fastening struts 25 which are profiled in a U-shaped manner.

An internal electric control device 32 of the drive system 1, onto which control device the control valve device 16 is connected for receiving electrical control signals is responsible for the electrical control of the control valve device 16 which specifies the operating state of the linear drive 2. By way of example, several electrical control leads 33 are provided, by way of which the two control valve units 16a, 16b are connected onto the internal electronic control device 32.

The internal electronic control device 32 is preferably subdivided into several control modules which are arranged distanced to one another and which by way of example comprise a main control module 32a and a supplementary control module 32b. The supplementary control module 32a is connected to the main control module 32a via an electric control lead 34. The control valve device 16 is expediently connected onto the supplementary control module 32b. The latter expediently contains or defines closed-loop control electronics 31 which in the context of a closed-loop control of the pressure of the fluid pressure which prevails in the drive chambers 13a, 13b permits an actuation of the drive unit 7 which is closed-loop controlled in its position.

The internal electronic control device 32 expediently has an electronic communication interface 39, by way of which a communication with an external electronic control device 35 which is only shown schematically is possible. The external electronic control device 35 for example specifies the desired stroke positions of the drive unit 7. Apart from the internal electronic control device 32 of the drive system 1, yet further systems whose operation which is matched to one another is coordinated by the external electronic control device 35 can be connected onto the external control device 35. The drive system 1 is preferably also capable of functioning in an autarkic manner without the external electronic control device 35.

The linear drive 2 can also be of an electrically actuatable nature, which is in contrast to the fluid-actuated construction type of the embodiment example. Then for example an electric motor as a drive source which can drive the drive unit 7 into a drive movement 8 via a spindle drive or via a toothed belt drive takes the place of the control valve device 16 and the pressure source P.

The drive unit 7 comprises a driven section 36 which is accessible outside the drive housing 6 and which is coupled in movement to the drive section 12 in a manner such that it synchronously participates in the linear drive movement 8. The driven section 36 given the drive movement 8 displaces along a linear path distance which can be denoted as a linear stroke path 37 and is illustrated in the drawing by a dot-dashed line. The driven section 36 is located partly or completely outside the drive housing 6.

The linear drive 2 is expediently of the construction type without a piston rod, which applies to the illustrated embodiment example. Here the linear stroke path 37 of the driven section 36 is located within the axial extension of the drive housing 6, so that the axial length of the linear drive 2 does not change given its use.

Concerning the preferred linear drive 2 of the embodiment example, the drive section 12 and the driven section 36 are arranged at least essentially at the same axial height with respect to the longitudinal axis 5. A longitudinal slot 86 which extends in the longitudinal direction 5 passes radially through the housing tube 22 which forms a peripheral housing wall 22a of the drive housing 6, through which a slot a driver section 87 of the drive unit 3 projects, said driver section coupling the drive section 12 to the driven section 36 with regard to the drive. In this manner, the drive movement 8 is always executed in a unitary manner by the drive section 12, the driver section 87 and the driven section 36.

Concerning an embodiment example which is not illustrated, the housing tube 22 is closed all around and the coupling between the drive section 12 and the driven section 36 with regard to drive is effected magnetically in a contact-free manner.

Basically, the linear drive 2 can also be designed as a linear drive with a piston rod which can be extended out of the drive housing.

The already mentioned interface module 4 has a preferably single-piece interface module body 38 which comprises a first mechanical fastening interface 42, via which it is fastened, in particular in a releasable manner, to an assembly interface 41 of the driven section 36 of the drive unit 7. By way of example, the first mechanical fastening interface 42 is located on a lower side 44 of the interface module body 38 which faces the drive housing 6.

The interface module body 38 furthermore has a second mechanical fastening interface 43, at which the working unit 3 is fastened to a further assembly interface 50, expediently likewise in a releasable manner The second mechanical fastening interface 43 is preferably located on an upper side 45 of the interface module body 38 which is opposite to the lower side 44.

The interface module body 38 has an imaginary height axis 38a which runs between the lower side 44 and the upper side 45 and is aligned in a radial manner with respect to the longitudinal axis 5 of the linear drive 2. The interface module body 38 furthermore has a longitudinal axis 38b which is at right angles to the height axis 38a and runs parallel to the longitudinal axis 5 on the linear drive 2. The interface module body 38 further has a transverse axis 38c which is at right angles to the height axis 38a as well as to the longitudinal axis 38b and which defines a width direction of the interface module body 38. The first mechanical fastening interface 42 preferably has a first assembly surface 46 which runs in a plane which is at right angles to the height axis 38a, and with which with this in front the interface module body 38 is applied onto the driven section 36 of the drive unit 7 in the region of the assembly interface 41.

The second mechanical fastening interface 43 expediently comprises a second assembly surface 47 which likewise runs at right angles to the height axis 38a and which is away from the first assembly surface 46. The working unit 3 is applied with the further assembly interface 50 onto the second assembly surface 47.

Expediently, each mechanical fastening interface 42, 43 is designed for the screw fastening of the components which are attached thereto, thus of the driven section 36 and the working unit 3. In this context, the first mechanical fastening interface 42 comprises a plurality of first fastening holes 48a, whilst the second mechanical fastening interface 43 comprises a plurality of second fastening holes 48b. The fastening holes 48a, 48b run out to the respectively assigned first or second assembly surface 46, 47 and permit the leading-through of fastening screws 49 which on the one hand are supported with their screw head on the interface module body 38 and on the other hand are screwed into threaded bores 52 of the driven section 36 and the working unit 3.

The hole pattern of the fastening holes 48a, 48b of the two fastening interfaces 42, 43 can be designed differently and in each case in accordance with requirements.

The working unit 3 which is fastened to the drive unit 7 via the interface module 4 participates in the drive movement 8 and carries out a linear working movement 53 which is equally oriented with regard to this. Hence the working unit 3 can be linearly displaced and positioned in accordance with requirements by way of a suitably controlled actuation of the linear drive 2 whilst carrying out the working movement 53.

The working unit 3 comprises at least one actuator device 54 which can be actuated by fluid force and which for the simplification is denoted as a fluid actuator device 54.

At least one and preferably each of the fluidic actuator devices 54 is expediently designed as a fluid-actuated drive, wherein by way of example a design as a fluid-actuated rotary drive 55 is present.

As in particular the FIGS. 2 and 3 illustrate, the fluid-actuated rotary drive 55 in particular is designed as a pivoting piston drive which comprises a pivotably mounted drive piston 56 which for an improved differentiation can be denoted as a pivoting piston 56 and which in a rotary drive housing 57 divides off two drive chambers 58a, 58b from one another. The pivoting piston 56 is fastened to a driven shaft 59 which is led out of the rotary drive housing 57. By way of a controlled fluid impingement of the two drive chambers 58a, 58b, the pivoting piston 56 can be driven into a pivoting movement with respect to the rotary drive housing 57, from which a rotational relative movement between the rotary drive housing 57 and the driven shaft 59 results.

According to the illustrated embodiment example, the drive system 1 is preferably designed as a robot 1a, wherein the working unit 3 represents a robot arm 3a of the robot 1a. Concerning the robot 1a, it is preferably a SCARA robot. Within the robot arm 3a, the fluid-actuated rotary drives 55 form active joints, by way of which the robot arm sections which are respectively attached to the rotary drive housing 27 and to the driven shaft 59 are actively pivotable relative to one another and are positionable relative to one another with regard to the rotation angle. By way of example, the robot arm 3a is provided with three fluid-actuated rotary drives 55 which function as joints. At least one such fluid-actuated rotary drive 55 can be designed as a carrier for an end-effector 62 of the robot 1a which is designed for example as a gripper.

Preferably, one of the fluid-actuated rotary drives 55 is fastened with its rotary drive housing 57 to the second mechanical fastening interface 43 of the interface module 4 in the manner which is described further above. The further assembly interface 50 is located on it. The driven shaft 59 which is rotatable with respect to this carries a pivotable robot arm section, on which a further fluid-actuated rotary drive 55 is seated. The design of the robot arm 3a is directed to the respective application demands.

The working unit 3 is also provided with at least one electrically actuatable actuator device 63 which is denoted as an electrical actuator device 63 for simplification.

By way of example, at least one and preferably each electrical actuator device 63 is designed as an electrically actuatable valve 64a of a control valve device 64 of the working unit 3 and is denoted as a working control valve device 64 for an improved differentiation.

The at least one working control valve device 64 by way of example serves for the fluidic control of at least one of the fluid-actuated rotary drives 55 and in this context is in the position of controlling the feed and the discharge of a fluidic pressure medium with respect to the two drive chambers 58a, 58b of the fluid-actuated rotary drive 55. Expediently, at least one working control valve device 64 is assembled on the rotary drive housing 57 of each fluid-actuated rotary drive 55.

One or each valve 64a of the working control valve device 64 is preferably a piezo-valve, but however can also for example be a magnet valve. By way of example, each valve 64b directly controls the fluid feed or the fluid discharge of a fluidic pressure medium into and out of one of the drive chambers 58a, 58b.

Alternatively, one or each working control valve device 64 is of the electro-fluidic pilot construction type, wherein it has a valve main stage which can be actuated by a valve drive which operates as an electrically actuatable pilot valve, wherein the valve drive represents an electrical actuator device 63.

For receiving and the discharging the pressure medium which is necessary for the operation of the at least one fluidic actuator device 54, the working unit 3 is provided with at least one connection device which for an improved differentiation is denoted as a fluidic working connection device 65.

At least one electrical working connection device 66 of the working unit 3 is designed for the feed and preferably also for the discharge of an electrical current which is necessary as a provider for electrical energy and/or electrical control signals with regard to the at least one electrical actuator device 63. In this context, it is to be mentioned that the working unit 3, for the control of the fluidic actuator devices 54 can comprise at least one individual electronic working unit control unit 69 which can communicate with the internal electronic control device 62 via the electrical working connection device 66.

The drive system 1 as a further component comprises an enveloping body 67 which encompasses the linear drive 2 at least peripherally, thus in its radially peripheral region. By way of this, the linear drive 2 is accommodated in a manner protected from environmental influences. Yet further constituents of the drive system 1, thus in particular the internal electronic control device 32 can be accommodated in the enveloping body interior 68 which is defined by the enveloping body 68 and which receives the linear drive 2

The enveloping body 67 in particular has a tubular wall section 72 which peripherally delimits the enveloping body interior 68 and radially encompasses the linear drive 2 to the outside. Its length preferably corresponds to the length of the linear drive 2. The enveloping body 67, at least in its tubular wall section 72 preferably consists of a plastic material. It can be designed in a relatively thin-walled manner

By way of example, the enveloping body 67 coming from the base structure 24 extends up to the opposite end region of the linear drive 2 which is assigned to the second housing end section 18b. It is evident from FIG. 1 that the enveloping body 67 can be open at the face side which is opposite the base structure 24, wherein in this case the enveloping body 67 as a whole can consist of the tubular wall section 72. The enveloping body 67 can however without further ado yet have at least one closure cover which closes the enveloping body interior 68 at the face side.

The enveloping body 67 is preferably fastened to a component of the linear drive 2 which is stationary with respect to the base structure 24. In this context, several fastening tabs 73 are evident in FIG. 3, via which fastening tabs the enveloping body 67 is attached to the fastening struts 25 of the linear drive 2. Additionally or alternatively, the enveloping body 67 can also be fastened directly to the base structure 24.

The enveloping body 67 has a longitudinal slot 74 which extends along the linear stroke path 37 of the driven section 36. This longitudinal slot 74 in particular is formed in the tubular wall section 72.

The interface module 4 is attached to the driven section 36 such that it projects through the longitudinal slot 74 of the enveloping body 67.Given the drive movement 8, the interface module 4 displaces along the longitudinal slot 74, whose length is dimensioned such that it does not block the linear stroke path of the interface module 4.

Expediently, the longitudinal slot 74 is shorter than the tubular wall section 72 of the enveloping body 67, so that the longitudinal slot 74 as a whole has the shape of an elongate window-like wall opening of the tubular wall section 72.

The interface module body 38 has an inner module body section 75 which is located in the inside of the enveloping body interior 68 and on which the first mechanical fastening interface 42 is formed.

The interface module body 38 furthermore has an outer module body section 76 which lies outside the enveloping body 67 and on which the second fastening location 43 is formed.

According to the illustrated preferred embodiment example, the inner module body section 75 has an inner fastening base 77, whilst the outer module body section 76 has an outer fastening base 78. The inner fastening base 77 comprises the first assembly surface 46, whilst the second assembly surface 47 is formed on the outer fastening base 78.

Both fastening bases 77, 78 are at least partially wider than the longitudinal slot 74 of the enveloping body 67 in the axis direction of the transverse axis 38c.

The two fastening bases 77, 78 are connected to one another as one piece by way of a connection web 82 of the interface module body 38. The connection web 82 extends through the longitudinal slot 74 and is relatively narrow in the axis direction of the transverse axis 38c, so that the slot width of the longitudinal slot 74 can also be designed in a very small manner. The connection web 82 preferably extends over the complete length of the interface body 38 which is measured in the axis direction of the longitudinal axis 38b.

The height of the connection web 82 which is measured in the axis direction of the height axis 38a is preferably larger than the wall thickness of the enveloping body 67 in the region which frames the longitudinal slot 74, so that an inner section of the connection web 82 belongs to the inner module body section 75 and an outer section of the connection web 82 to the outer module body section 76.

The interface module body 38 has two first and second end-faces 83a, 83b which are opposite to one another and are orientated in the axis direction of the longitudinal axis 38b. Whereas the inner fastening base 77 expediently extends over the complete length of the interface module body 38 and thus from the first end-face 83a up to the second end-face 83b, the outer fastening base 78 preferably has shorter length dimensions. By way of example, the outer fastening base 78 coming from the first end-face 83a only extends over a part-length of the interface module body 38 and ends at a distance in front of the second end-face 83b, so that a length section of the connection web 82 which is denoted as a free length section 84 remains, said length section extending axially between the outer fastening base 78 and the second end-face 83b and not being covered by the outer fastening base 87. The non-covered surface of the free length section 84 of the connection web 82, said surface lying on the upper side 45 of the connection interface module body 38, is hereinafter denoted as a connection surface 85.

Herewith, the interface module body 38 is stepped over its longitudinal direction on the upper side 45. In the region of the outer fastening base 78, it has a greater height in the axis direction of the height axis 38a than in the region of the free length section 84 of the connection web 82.

In order to ensure a particularly secure fixation of the working unit 3 on the interface module 4, it is advantageous if the outer fastening base 78 comprises at least two centring deepenings 88 which are distanced to one another, are open to the second assembly surface 47 and into which a centring projection 89 which is formed in the working unit 3 engages. On account of the interaction of the centring deepenings 88 and the centring projections 89, in particular a mutual positive support between the working unit 3 and the interface module body 38 results in a plane which is at right angles to the height axis 38.

Preferably, at least one centring deepening 88 is formed in the region of the first end-face 83a and on the side of the assembly surface 47 which is opposite with respect to this.

The interface module 4 apart from its fastening function yet also has the function of a transmission of fluid pressure medium and of the electric current between the stationary constituents of the drive system 1 and of the working unit 3.

In this context, at least one fluid transmission channel 92 and at least one electricity transmission channel 93 passes through the interface module body 38. Whereas only a single electricity transmission channel 93 is present by way of example, the embodiment example comprises two fluid transmission channels 92.

Each fluid transmission channel 92 runs out with an inner channel opening 92a at the inner module body section 75 and with an outer channel opening 92 at the outer module body section 76. Furthermore, each electricity transmission channel 93 runs out with an inner channel opening 93a at the inner module body section 75 and with an outer channel opening 93b at the outer module body section 76.

Each fluid transmission channel 92 is peripherally closed all around and passes through the interface module body 38 in the manner of a possibly angled bore.

The inner channel openings 92a of the fluid transmission channels 92 are preferably arranged on a longitudinal side of the inner fastening base 77 which is orientated in the axis direction of the transverse axis 38c. They are therefore easily accessible for connection measures also in the state of the interface module 4 being assembled on the drive section 36.

The outer channel openings 92b of the fluid transmission channels 92 are preferably located on the upper side 45 of the interface module body 38, wherein however they are expediently placed away from the second assembly surface 47, so that they are easily accessible for connection measures irrespectively of the working unit 3 which is assembled on the second assembly interface 47. Expediently, these external channel openings 92b are located on the connection surface 85 of the free length section 84 of the connection web 82.

Expediently, an inner tube connection unit 94a is arranged on each inner channel opening 92a. In a comparable manner, an outer tube connection unit 94b which is likewise not shown in all figures is arranged on each outer channel opening 92b. The tube connection units 94a, 94b are expediently screwed into the assigned channel opening 92a, 92b. They are designed in order to be able to connect a flexible fluid tube which is suitable for leading a pressure medium, in a releasable manner.

The fluid transmission channels 92 serve for leading through a fluidic pressure medium which is used for the operation of the at least one fluidic actuator device 65 of the working unit 3. The pressure medium comes from the pressure source P which is already mentioned further above and is led within the enveloping body interior 68 through a bending-flexible fluid tube arrangement 95 onto the inner channel openings 92a of the interface module body 38.

The fluid tube arrangement 95 has an a length section which extends exclusively in the enveloping body interior 68, is denoted as an inner fluid tube section 85a and connects the inner channel openings 92a of the fluid transmission channels 92 to a stationary fluidic working connection device 96 which is connected on the one hand to the pressure source P and on the other hand to the pressure sink R. The fluidic working connection device 96 is expediently formed by the drive connection device 17, so that no separate connection device is necessary. For example, the inner fluid tube section 95a as is drawn can be branched from the valve connection channels 23a, 23b. The connection onto the inner channel openings 92a is effected by way of the inner tube connection units 94a which are attached thereto.

Given the drive movement 8, the inner tube connection units 94a move together with the interface module 4 whilst executing the drive movement 8. Herein, the inner fluid tube section 95a can bend in a flexible manner.

Outside the enveloping body 67, the bending-flexible fluid tube arrangement 95 continues with a separate length section which is denoted as an outer fluid tube section 95b and is connected at one end via the outer tube connection units 94b onto the outer channel openings 92b of the fluid transmission channels 92 and at the other end onto the fluidic working connection device 65 of the working unit 3. The bending-flexible fluid tube arrangement 95 is therefore composed of the inner fluid tube section 95a which is led onto the interface module 4 and of the outer fluid tube section 95b which leaves the interface module 4.

The bending-flexible fluid tube arrangement 95 preferably consists of two parallel fluid tube lines, wherein the inner fluid tube section 95a and the outer fluid tube section 95b are each composed of two functionally parallel individual bending-flexible fluid tubes. The fluidic pressure medium is fed from the pressure source P via the one fluid tube line and the discharge of the pressure medium to the pressure sink R via the other fluid tube line.

The electric electricity supply of the working unit 3 is effected by way of a bending-flexible electricity cable arrangement 97 which extends in the enveloping body interior 68 between the internal electronic control device 32 and the inner channel opening 93a of the electricity transmission channel 93 of the interface module 4. In contrast to the fluid tube arrangement 95, the electricity cable arrangement 97 however extends in a continuous manner also through the interface module body 38 and does not end until at the electrical working connection device 66 of the drive unit 3 outside the enveloping body 67.

The electric current is therefore led through the interface module 4 by way of the bending-flexible electricity cable arrangement 97 which is envisaged for leading the electricity being laid through the electricity transmission channel 7.

The electricity cable arrangement 97 has a length section which is denoted as an inner electricity cable section 97a and which extends in the inside of the enveloping body 67 between the internal electronic control device 32 and the interface module 4 and it further has a length section which is denoted as an outer electricity cable section 97b and which extends outside the enveloping body 67 between the interface module 4 and the working unit 3. An intermediate electricity cable section 97c which connects the inner and the outer electricity cable section 97a, 97b extends through the electricity transmission channel 93.

On the part of the internal electronic control device 32, the electricity cable arrangement 97 is preferably connected onto the supplementary control module 32 which is provided with the closed-loop control electronics 31.

The inner electricity cable section 97a of the bending-flexible electricity cable arrangement 97 can bend without any problem without assuming damage, given a linear movement of the interface module 4.

The bending-flexible electricity cable arrangement 97 expediently consists of a bending-flexible flexible bus cable which comprises the necessary number of electrically conductive cores, in order to be able to transmit the electrical current in a suitably processed form for the energy supply and/or for the electrical control.

The electricity cable arrangement 97 by way of example is designed with the electrical control lead 34 as a uniform control lead which is dragged through the supplementary control module 32. The electric control lead 34 here therefore is a length section of the bending-flexible electricity cable arrangement 97.

The electricity transmission cable 93 can in principle be designed in a manner comparable to a fluid transmission channel 92 in the manner of a bore in the interface module body 38. The through-laying of a continuous electric cable arrangement 97 is however considerably simplified if the electricity transmission cable 93 is designed in a groove-like manner as with the embodiment example

The groove-like electricity transmission channel 93 which is hereinafter denoted as an electricity transmission groove 93 for simplification is formed in the interface module 38 laterally at the outside and extends in the axis direction of the height axis 38a.

Expediently, the electricity transmission groove 93 is located on one of the two end-faces which face in the longitudinal direction 38 of the interface module body 38, wherein it is formed by way of example on the second end-face 83b which is located on the free length end section 84 of the connection web 82 at the face side. Accordingly, a channel longitudinal axis 98 of the groove-like electricity transmission channel 93 runs in the axis direction of the height axis 38a of the interface module body 38. This is simultaneously the longitudinal axis of the electricity transmission groove 93.

Accordingly, the groove like electricity transmission channel 93 has two face-side channel openings, of which the one bears on the lower side 44 and the other on the upper side 45 of the interface module body 38 and between which a slot-like longitudinal-side channel opening 99 which is open in the axis direction of the longitudinal axis 38b extends. The two inner and outer channel openings 93a, 93b are each formed by that length channel section of the electricity transmission groove 93 which is located within or outside the longitudinal slot 74 of the enveloping body 67.

The electricity cable arrangement 97 enters into the electricity guide groove 93 in the region of the inner channel opening 93a and then with the intermediate electricity cable section 97c runs in the inside of the electricity transmission groove 93 and finally exits at the outer channel opening 93b with the outer electricity cable section 97b which runs to the drive unit 3.

It is advantageous if one or more binder holes 100 which run out into the electricity transmission groove 93 in the region of the groove flanks pass through the interface module body 38 in the region of the electricity guide groove 93. Each binder hole 100 is suitable for leading through for example a bendable binding element 101 which is formed for example by a so-called cable binder and which is wrapped around the intermediate electricity cable section 97c and fixedly holds this within the electricity guide groove 93.

The fluid tube arrangement 95 and the electricity cable arrangement 97 are led within the enveloping body interior 68 expediently through a support device 102 which has a longitudinal extension, is designed in a flexible manner transversely to its longitudinal extension and simultaneously develops a protective effect by way of it preventing uncontrolled movements of the fluid tube arrangement 95 and the electricity cable arrangement 97 and a clamping between parts which are moved relative to one another.

The support device 102 is preferably formed by a so-called drag chain 103 which also applies to the illustrated embodiment example.

The drag chain 103 has a multitude of chain links 104 which are rowed on one another in an articulated manner and which encompass an axially continuous chain cavity 105, through which a fluid tube arrangement 95 and the electricity cable arrangement 97 extend.

The drag chain 103 has a first fastening end 106, with which it is assembled in a stationary manner with respect to the drive housing 6, wherein the first fastening end 106 by way of example is attached to one of the two fastening struts 25. An axially opposite second fastening end 107 of the drag chain 103 is fastened to the inner module body section 75 of the interface module body 38. This inner module body section 75 for the attachment of the second fastening end 109 comprises a third mechanical fastening interface 108 which in particular is designed for screw fastening the second fastening end 107 of the drag chain 103.

For example, the third fastening interface 108 comprises several fastening holes 109 which are designed as threaded holes and to which the second fastening end 107 is fixedly screwed by way of fastening screws 110.

The third fastening interface 108 is preferably formed on one of the two longitudinal sides of the inner fastening base 77 which are orientated in the transverse direction 38c. It can be located on the same longitudinal side as the inner channel openings 92a of the fluid transmission channels 92. A third fastening interface 108 can also be present in multiple and be located at different locations of the inner module body section 75.

Here, it is to be mentioned that the fluid transmission channels 92 can branch within the interface module body 38, so that they each run out with several inner channel openings 92 at different locations at the inner module body section 95. The inner channel openings 92a which are not necessary are closed by way of closure plugs.

The drag chain 103 expediently has a longitudinal course which is bent away at least once. According to the illustrations, it can be led around the interface module 4 once at the face side.

The chain cavity 105 is open at both fastening ends 106, 107 in order to permit the entry and exit of the fluid tube arrangement 95 and the electricity cable arrangement 97.

1. A drive system, comprising a linear drive which has a drive housing and a drive unit wherein the drive unit is displaceable with respect to the drive housing in the axis direction of a longitudinal axis of the linear drive whilst carrying out a linear drive movement, wherein the drive unit comprises a driven section which is accessible outside the drive housing and which moves along a linear stroke path given the drive movement, and with a working unit which is linearly displaceable and positionable by the drive movement of the drive unit, is fastened to the driven section of the drive unit and comprises at least one electrically actuatable electrical actuator device and
(a) wherein the working unit also comprises at least one fluidic actuator device which can be actuated by fluid force,
(b) wherein the working unit is fastened to the driven section of the linear drive amid the intermediate arrangement of an interface module which participates in the drive movement, wherein the interface module comprises an interface module body which has a first mechanical fastening interface and a second mechanical fastening interface and which is fastened to the driven section via the first mechanical fastening interface and to whose second mechanical fastening interface the working unit is fastened,
(c) wherein the drive system comprises an enveloping body which at least peripherally encompasses the linear drive and which comprises a longitudinal slot which extends along the linear stroke path of the driven section of the linear drive and through which the interface module projects, wherein an inner module body section of the interface module body which comprises the first mechanical fastening interface is arranged within an enveloping body interior which receives the linear drive, and an outer module body section of the interface module body which comprises the second mechanical fastening interface is arranged outside this enveloping body interior,
(d) wherein at least one fluid transmission channel passes through the interface module body and with an inner channel opening runs out at the inner module body section and with an outer channel opening runs out at the outer module body section, the at least one fluid transmission channel being designed for the fluid transmission of a fluidic pressure medium which is provided for the operation of the at least one fluidic actuator device,
(e) wherein at least one electricity transmission channel passes through the interface module body and with an inner channel opening runs out at the inner module body section and with an outer channel opening runs out at the outer module body section, at least one electricity transmission channel being designed for electricity transmission of an electrical current which is provided for the operation of the at least one electrical actuator device,
(f) wherein inside the enveloping body interior a flexible fluid tube arrangement which is designed for the transmission of the fluidic pressure medium is fed onto the inner channel opening of the at least one fluid transmission channel, and
(g) wherein furthermore inside the enveloping body interior a bending-flexible electricity cable arrangement which is designed for the transmission of the electrical current is fed onto the inner channel opening of the at least one electricity transmission channel,
(h) wherein at least one fluid connection to the working unit is formed coming from the outer channel opening of the at least one fluid transmission channel and wherein at least one electrical connection to the working unit is formed coming from the outer channel opening of the at least one electricity transmission channel.

2. The drive system according to claim 1, wherein the linear drive is of an electrically actuatable type and/or of a type which can be actuated by fluid force.

3. The drive system according to claim 1, wherein the linear drive is of a piston rod-less type, wherein the drive unit comprises a drive section, said drive section being linearly movable in the drive housing, being able to be subjected to a drive force which creates the drive movement and with regard to drive being coupled through a peripheral housing wall of the drive housing to the driven section which is arranged outside the drive housing.

4. The drive system according to claim 1, wherein the electricity cable arrangement and the fluid tube arrangement are fed through a support device which is arranged in the enveloping body interior, is fastened at one end in a stationary manner with respect to the drive housing of the linear drive and at the other end to the interface module body in a stationary manner, wherein the support device on the part of the interface module body is fastened to a third mechanical fastening interface of the interface module body which is formed on the inner module body section.

5. The drive system according to claim 1, wherein, each mechanical fastening interface is designed for the screw fastening of the components which are attached thereto.

6. The drive system according to claim 1, wherein the inner module body section comprises an inner fastening base which forms the first mechanical fastening interface, and the outer module body section comprises an outer fastening base which forms the second mechanical fastening interface, wherein the two fastening bases are connected to one another by a connection web which is narrower than each of the two fastening bases and which projects through the longitudinal slot of the enveloping body, the width of which likewise being smaller than the width of each one of the two fastening bases.

7. The drive system according to claim 6, wherein the outer fastening base is shorter in the longitudinal direction of the linear drive than the inner fastening base.

8. The drive system according to claim 6, wherein the outer fastening base comprises at least two centring deepenings which are distanced to one another and into which a centring projection of the working unit positively engages, respectively, said working unit being attached to the outer fastening base.

9. The drive system according to claim 1, wherein, the electricity cable arrangement is laid through the at least one electricity transmission channel, wherein it enters into the electricity transmission channel at the inner channel opening and exits from the electricity transmission channel at the outer channel opening.

10. The drive system according to claim 9, wherein at least one electricity transmission channel is designed in a groove-like manner, so that it comprises two face-side channel openings and a slot-like longitudinal-side channel opening-(994, wherein it is located on an end-face of the interface module body, said end-face facing in the longitudinal direction of the linear drive, and is aligned in a manner such that its channel longitudinal axis extends at right angles to the longitudinal axis of the linear drive.

11. The drive system according to claim 10, wherein one or more binder holes which in the region of the groove flanks run out into the groove-like electricity transmission channel pass through the interface module body, through which binder holes a bendable binder element which fixedly holds an electricity cable arrangement which is laid in the electricity transmission channel can be led or is led.

12. The drive system according to claim 1, wherein the interface module body has a longitudinal axis which is parallel to the longitudinal axis of the linear drive, a height axis which is orientated radially with respect to the longitudinal axis of the linear drive and a transverse axis which is at right angles to the longitudinal axis and to the height axis, wherein the inner channel opening of the at least one fluid transmission channel is arranged on a longitudinal side which is orientated in the axis direction of the transverse axis and the assigned outer channel opening is arranged on an upper side of the interface module body which is orientated in the axis direction of the height axis.

13. The drive system according to claim 12 wherein the outer fastening base is shorter in the longitudinal direction of the linear drive than the inner fastening base, wherein the outer channel opening of the at least one fluid transmission channel is arranged on the connection web.

14. The drive system according to claim 1, wherein, an inner and outer tube connection unit is arranged on the interface module body of the interface module on the inner and outer channel opening respectively of the at least one fluid transmission channel, wherein the fluid tube arrangement comprises at least one inner fluid tube section which extends in the enveloping body interior and at least one outer fluid tube section which extends outside the enveloping body, wherein each inner fluid tube section is connected onto an inner tube connection unit and each outer fluid tube section is connected onto an outer tube connection unit

15. The drive system according to claim 1, wherein the electricity cable arrangement is connected in the enveloping body interior onto an internal electronic control device.

16. The drive system according to claim 1, wherein the enveloping body is fastened to the drive housing of the linear drive and/or comprises a tubular wall section which has the longitudinal slot.

17. The drive system according to claim 1, wherein at least one fluidic actuator device of the working unit is a fluid-actuated rotary drive and/or wherein at least one electrical actuator device of the working unit is a valve drive which belongs to a control valve device of the working unit.

18. The drive system according to claim 1, wherein the drive system forms a robot, wherein the working unit is a robot arm of the robot.

19. The drive system according to claim 3, wherein the drive section with regard to drive is coupled to the driven section by a driver section of the drive unit which passes through a longitudinal slot of the peripheral housing wall of the drive housing.

20. The drive system according to claim 4, wherein the support device is formed by a drag chain.

21. The drive system according to claim 9, wherein the electricity cable arrangement is electrically connected to the working unit with an outer electricity cable section which exits from the electricity transmission channel at the outer channel opening.

22. The drive system according to claim 15, wherein the fluid tube arrangement in the enveloping body interior is connected onto a fluidic connection device which is designed for feeding and discharging a fluidic pressure medium.
